(19) United States
(12) Patent Application Publication
(10) Pub. No.: US 2025/0343722 A1
(43) Pub. Date: Nov. 6, 2025

(54) Enhanced Link Adaptation Method, Communication Device, and System for Unequal Quadrature Amplitude Modulation

(71) Applicant: MEDIATEK INC., Hsinchu City (TW)

(72) Inventors: Shuling Feng, San Jose, CA (US); Jianhan Liu, San Jose, CA (US); Thomas Edward Pare, JR., San Jose, CA (US); You-Wei Chen, San Jose, CA (US); Yonggang Fang, San Jose, CA (US)

(73) Assignee: MEDIATEK INC., Hsinchu City (TW)

(21) Appl. No.: 19/196,761

(22) Filed: May 2, 2025

Related U.S. Application Data
(60) Provisional application No. 63/641,975, filed on May 3, 2024.

(51) Int. Cl. H04L 27/34; H04B 17/309

(52) U.S. Cl. CPC H04L 27/34; H04B 17/346

(57) ABSTRACT

An enhanced link adaptation (eELA) method includes receiving, by a responding device from a requesting device, a physical layer protocol data unit (PPDU) including an eELA request message, determining, by the responding device, an eELA feedback message comprising unequal quadrature amplitude modulation (UEQM) information across a plurality of spatial streams based on at least the number of spatial streams derived from the eELA request message or the PPDU, and transmitting, from the responding device to the requesting device, the eELA feedback message. The UEQM information indicates an effective Signal-to-Noise Ratio (SNR) per spatial stream or a derivative of the effective SNR per spatial stream.

### CROSS REFERENCE TO RELATED APPLICATIONS

This application claims the benefit of U.S. Provisional Application No. 63/641,975, filed on May 3, 2024. The content of the application is incorporated herein by reference.

### BACKGROUND

Conventional link adaptation in wireless systems like IEEE 802.11 Extremely High Throughput (EHT), known as Enhanced Link Adaptation (ELA), utilizes Modulation and Coding Scheme (MCS) Request/Feedback (MRQ/MFB) messages. The recommended MCS is often fed back via A-control fields in MFB message for Fast Link Adaptation (FLA), with algorithms typically relying on Packet Error Rates (PER) derived from acknowledgments (ACK or Block Ack).

However, conventional ELA technologies have several limitations. Reliability and interoperability issues arise from varying MCS Feedback (MFB) implementations across vendors, hindering FLA effectiveness. Furthermore, existing feedback mechanisms are not optimized for transmissions employing unequal quadrature amplitude modulation (UEQM) across spatial streams. The UEQM is a modulation technology for enhancing performance in next-generation networks. The ability to support unequal modulation across spatial streams is becoming increasingly important for next-generation wireless systems to provide higher spectral efficiency and performance. In conventional ELA feedback, while adding margin Signal-to-Noise Ratio (SNR) per stream offers some benefit even for equal modulation (EQM), it is considered necessary but insufficient for robust UEQM.

Consequently, an enhanced link adaptation feedback approach that fully supports the UEQM scenario is needed, improving overall link adaptation performance and reliability.

### SUMMARY

In an embodiment, an enhanced link adaptation (eELA) method is disclosed. The eELA method comprises receiving, by a responding device from a requesting device, a physical layer protocol data unit (PPDU) comprising an eELA request message, determining, by the responding device, an eELA feedback message comprising unequal quadrature amplitude modulation (UEQM) information across a plurality of spatial streams based on at least the number of spatial streams derived from the eELA request message or the PPDU, and transmitting, from the responding device to the requesting device, the eELA feedback message. The UEQM information indicates an effective Signal-to-Noise Ratio (SNR) per spatial stream or a derivative of the effective SNR per spatial stream.

In another embodiment, a communication device is disclosed. The communication device comprises a transceiver and a processor. The transceiver is configured to communicate wirelessly. The processor is coupled to the transceiver and configured to perform operations comprising: receiving, via the transceiver, a physical layer protocol data unit (PPDU) comprising an eELA request message, determining an eELA feedback message comprising unequal quadrature amplitude modulation (UEQM) information across a plurality of spatial streams based on at least the number of spatial streams derived from the eELA request message or the PPDU, and transmitting, via the transceiver, the eELA feedback message. The UEQM information indicates an effective Signal-to-Noise Ratio (SNR) per spatial stream or a derivative of the effective SNR per spatial stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an enhanced link adaptation (eELA) system according to an embodiment of the present invention.

FIG. 2 is a schematic diagram of hardware components of the eELA system in FIG. 1.

FIG. 3 is a schematic diagram of receiving an eELA request message and transmitting an eELA feedback message by a responding device of the eELA system in FIG. 1.

FIG. 4 is a flow chart of performing an eELA method by the eELA system in FIG. 1.

### DETAILED DESCRIPTION

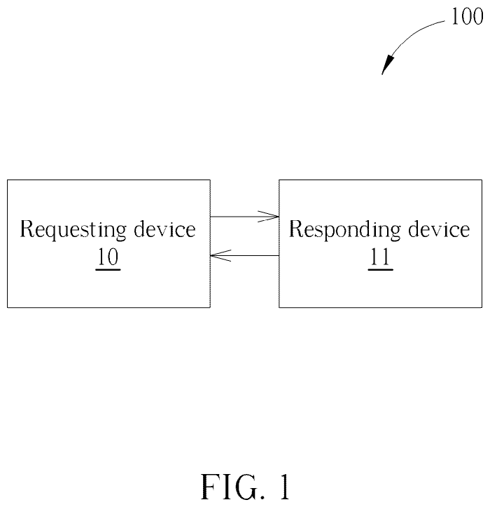

FIG. 1 is a schematic diagram of an enhanced link adaptation (eELA) system 100 according to an embodiment of the present invention. The eELA system 100 is designed to address limitations in existing Wi-Fi link adaptation mechanisms, especially in the enhanced link adaptation used in Extremely High Throughput (EHT) standards like IEEE 802.11be. The eELA system 100 proposes a solution by enhancing the current enhanced link adaptation subfield to incorporate more feedback information for the unequal quadrature amplitude modulation (UEQM) scenario. The feedback information may comprise an effective SNR per SS or a derivative of the effective SNR per SS. Particularly, the effective SNR is derived by using Received Bit Mutual Information Rate (RBIR) estimations. Using the RBIR-based effective SNR takes advantage of higher accuracy in reflecting true channel conditions compared to average SNR or packet error rate (PER) metrics. Further, the eELA system 100 enables robust support for UEQM, leading to higher throughput and better link performance by allowing more granular adaptation across spatial streams. The use of the more accurate and effective SNR metric leads to better MCS and QAM pattern recommendations, improving overall link adaptation performance.

In FIG. 1, the eELA system 100 includes a requesting device 10 and a responding device 11. The requesting device 10 is configured to send a physical layer protocol data unit (PPDU) including an eELA request message. The requesting device 10 can logically function as either an Access Point (AP) or a Station (STA), operating within an Orthogonal Frequency-Division Multiplexing (OFDM) based Multiple-Input Multiple-Output (MIMO) wireless communication framework, capable of performing adaptations across multiple spatial streams. The responding device 11 is configured to send a feedback message based on at least the number of spatial streams derived from the eELA request message or the PPDU. Similarly, the requesting device 10 can logically function as either the AP or the STA, operating within the OFDM-based MIMO wireless communication framework. In FIG. 1, the requesting device 10 and the responding device 11 interact and negotiate with each other to perform the eELA procedure. For example, the responding device 11 receives a physical layer protocol data unit (PPDU) including an eELA request message transmitted from the requesting device 10. Then, the responding device 11 determines the eELA feedback message including UEQM information used to a link adaptation across a plurality of spatial streams based on the eELA request message or the PPDU. Then, the responding device 11 transmits the eELA feedback message within a block acknowledgment (Ack) frame to the requesting device 10.

In this embodiment, the eELA procedure between the requesting device 10 and the responding device 11 helps the requesting device 10 to select accurate parameters for enhanced-enhanced link adaptation. The core technology of the eELA procedure lies in the eELA feedback mechanism. For example, the responding device 11 transmits UEQM information to the requesting device 10 via an eELA feedback message. The UEQM information includes the effective SNR calculated for each spatial stream (effective SNR per SS) or a derivative of the effective SNR per SS. The effective SNR per SS provides a granular and accurate channel condition. The requesting device 10 performs a link adaption operation based on the eELA feedback message. For example, the requesting device 10 may select appropriate parameters (e.g., selecting appropriate MCS and UEQM patterns) for future communications and perform communications based on the appropriate parameters. For example, the eELA procedure enables more accurate modulation schemes (such as QAM order or MCS) applied to each spatial stream.

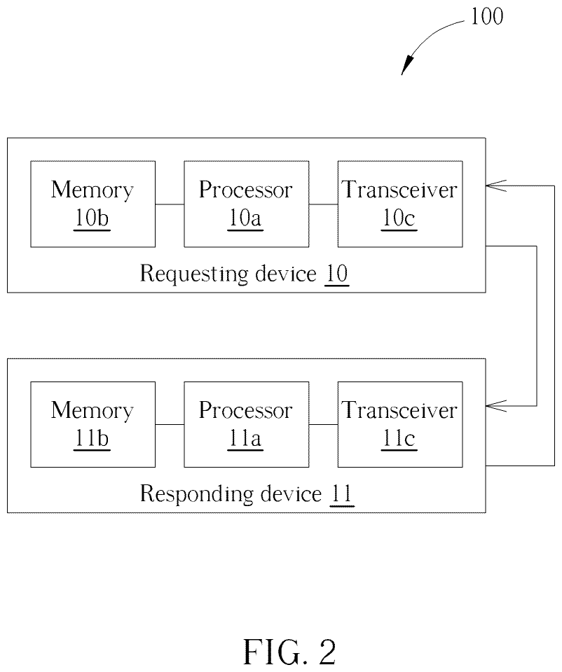

FIG. 2 is a schematic diagram of the eELA system 100. The requesting device 10 includes a processor 10a, a memory 10b, and a transceiver 10c. The processor 10a is coupled to the memory 10b and the transceiver 10c. The processor 10a is configured to execute program instructions stored in the memory 10b and to process data related to communication protocols and the eELA procedure. For instance, the processor 10a can be used for generating the eELA request message intended to solicit specific feedback from the responding device 11, wherein the eELA request message is carried by the PPDU, processing received eELA feedback messages obtained through the transceiver 10c, interpreting the UEQM information contained therein (such as effective SNR per spatial stream, recommended MCS, or recommended QAM pattern), and making subsequent link adaptation decisions (e.g., selecting appropriate MCS and UEQM patterns for future transmissions to the responding device 11 based on the UEQM information). The processor 10a may be implemented using one or more central processing units (CPUs), microcontrollers, digital signal processors (DSPs), application-specific integrated circuits (ASICs), field-programmable gate arrays (FPGAs), or other suitable processing circuitry.

The memory 10b is coupled to the processor 10a and provides storage for various types of information. The information can include but is not limited to, operating system software, firmware, communication protocol stacks (e.g., implementing relevant IEEE 802.11 standards), algorithms related to the eELA procedure, configuration parameters for the requesting device 10, temporary data generated or used during processing (e.g., buffered PPDUs, received feedback values), and potentially pre-calculated tables or models used for the link adaptation decisions. The memory 10b can encompass various forms of volatile memory (e.g., Random Access Memory) and/or non-volatile memory (e.g., Read Only Memory, Flash memory, Solid State Drive).

The transceiver 10c is coupled to the processor 10a. The transceiver 10c is configured for both transmission and reception of radio frequency (RF) signals according to the applicable wireless communication standards (e.g., Wi-Fi). In the eELA procedure, the transceiver 10c is configured to transmit the PPDU including the eELA request message to the responding device 11. The transceiver 10c is also configured to receive signals from the responding device 11, such as the block acknowledgment (Ack) frame which may contain the eELA feedback message.

Similarly, the responding device 11 includes a processor 11a, a memory 11b, and a transceiver 11c. The processor 11a is coupled to the memory 11b and the transceiver 11c. The processor 11a is configured to execute instructions stored in memory 11b and perform tasks complementary to the requesting device 10 within the eELA procedure. For example, upon receiving the PPDU including the eELA request message through the transceiver 11c from the requesting device 10, the processor 11a determines parameters (e.g. the number of spatial streams (Nss)) derived from the eELA request message or the PPDU. Based on the parameters derived from the eELA request message or the PPDU and its assessment of the received signal quality, the processor 11a can generate UEQM information. The UEQM information may comprise recommended MCS, recommended QAM pattern, margin-effective SNR per spatial stream, delta-effective SNR per spatial stream, and/or the effective SNR per spatial stream. The processor 11a prepares the eELA feedback message comprising the UEQM information and provides it to the transceiver 11c for transmission back to the requesting device 10, embedded within a block Ack frame. Like processor 10a, processor 11a can be implemented using various processing technologies.

The memory 11b stores necessary instructions and data for the processor 11a, including software, protocols, eELA processing algorithms (e.g., for RBIR and effective SNR calculation, feedback generation logic), and received request details. The memory 11b can also be a volatile memory or a non-volatile memory.

The transceiver 11c of the responding device 11 performs the wireless transmission and reception functions. The transceiver 11c receives the PPDU including the eELA request message from the requesting device 10. Under the control of processor 11a, the transceiver 11c transmits the block Ack frame containing the eELA feedback message to the requesting device 10.

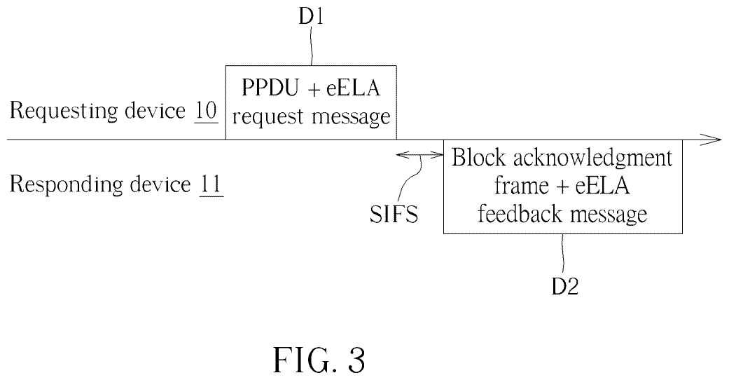

FIG. 3 is a schematic diagram of receiving a PPDU carrying an eELA request message and transmitting a block acknowledgment (block Ack) frame carrying an eELA feedback message by a responding device 11 of the eELA system 100. In FIG. 3, the X-axis is a timeline. In FIG. 3, “PPDU+eELA request message” means that the PPDU carries the eELA request message. “Block acknowledgment frame +eELA feedback message” means that the Block acknowledgment frame carries the eELA feedback message.

The mechanism for the link adaptation procedure may provide the effective SNR per spatial stream or a derivative of the effective SNR per spatial stream during distinct phases, including an initial setup phase driven by the sounding procedure and a subsequent operational phase involving eELA. The sounding procedure establishes the initial parameters for communication between the requesting device 10 and the responding device 11, for example, initial selection parameters such as the number of spatial streams (Nss), MCS, and QAM pattern. In other words, the responding device 11 obtains initial transmission parameters (Nss, MCS, QAM pattern) by leveraging the effective SNR per spatial stream or a derivative of the effective SNR per spatial stream obtained in the sounding procedure. The effective SNR per spatial stream or a derivative of the effective SNR per spatial stream is explicitly included in or derived from the sounding feedback report, enables more accurate initial parameters selection.

After sounding, as shown in FIG. 3, the requesting device 10 transmits a packet D1 to the responding device 11. Packet D1 is the PPDU including the eELA request message. The eELA request message can be carried by the PPDU. A purpose of the eELA request message is to solicit specific link adaptation feedback information from the responding device 11. For example, the eELA request message is relevant to the type of feedback information needed, such as feedback information pertinent to UEQM operation. The feedback information may relate to parameters including the number of spatial streams, desired Quadrature Amplitude Modulation (QAM) patterns, or metrics such as the effective SNR.

Upon the successful reception of packet D1 (the PPDU including the eELA request message) by the responding device 11, a time interval (e.g., Short Inter-Frame Space, SIFS) must elapse before the responding device 11 is permitted to transmit a response. It should be understood that SIFS is a period of minimal and precisely defined time duration used in Carrier Sense Multiple Access with Collision Avoidance (CSMA/CA) protocols, such as IEEE 802.11 (Wi-Fi), to ensure that high-priority frames like acknowledgments can be accessed or transmitted quickly after the completion of the preceding frame reception.

Following the expiration of the SIFS interval, the responding device 11 transmits a response frame, represented as packet D2, to the requesting device 10. In the embodiment, the packet D2 may be the block acknowledgment (block Ack) frame. The block Ack frame is an efficient mechanism defined in IEEE 802.11 standards that allows the acknowledgment of multiple previously received data units (e.g., the MSDUs within the PPDU of D1) with a single acknowledgment frame, thereby reducing overhead. Further, in the embodiment, the block Ack frame comprises the eELA feedback message. The eELA feedback message can include specific information for the link adaptation solicited by the requesting device 10 via the eELA request message. In one embodiment, the eELA feedback message includes UEQM information, such as at least the effective SNR per spatial stream, the recommended MCS, the QAM patterns, the margin-effective SNR, and/or the delta-effective SNR. Details of different eELA schemes are illustrated below.

In the embodiments, the eELA feedback message can improve link adaptation operations in next-generation wireless networks (e.g., next-generation Wi-Fi). Further, the eELA feedback message contains UEQM information. Including the UEQM information enables link adaptation for transmissions utilizing both UEQM and Equalization Modulation (EQM). Furthermore, the specific content and size of this UEQM information within the eELA feedback message can adhere to any one of several schemes presented in Table T1.

TABLE T1

| | |
|---|---|
| eELA | (1) Recommended MCS for requesting Nss and QAM pattern: |
| scheme 1: | 1 extra bit |
| | (2) Margin-effective SNR/SS: 3 or 4 bits/SS |
| eELA | (1) Recommended MCS and QAM pattern for requesting Nss: |
| scheme 2: | 3 or 4 extra bits |
| | (2) Margin-effective SNR/SS: 3 or 4 bits/SS |
| eELA | (1) Margin-effective SNR/SS for requesting Nss, MCS, and |
| scheme 3: | QAM pattern: 3 or 4 bits/SS |
| eELA | (1) Recommended equal MCS for requesting Nss: 1 extra bit |
| scheme 4: | (2) Margin-effective SNR/SS: 3 or 4 bits/SS |
| eELA | (1) A common offset for effective SNR: 6 bits |
| scheme 5: | (2) Delta-effective SNR/SS for requesting Nss, requesting |
| | QAM pattern or a pre-designed high order QAM (for example |
| | 256 QAM or 1024 QAM): 4 bits |
| eELA | (1) Effective SNR/SS for requesting Nss, requesting QAM |
| scheme 6: | pattern or a pre-designed high order QAM (for example 256 |
| | QAM or 1024 QAM): 6 bits/SS |

The eELA scheme 1 defines the UEQM information within the eELA feedback message, applicable when the corresponding eELA request message specifies or the PPDU carrying the eELA request message implies the number of spatial streams (Nss) and the Quadrature Amplitude Modulation (QAM) pattern. The responding device 11 determines the eELA feedback message including two components based on the Nss and the QAM pattern. The first component is used for indicating the recommended MCS specifically chosen for the Nss and QAM pattern combination, the number of bits of this component is one more than the number of bits of MCS indication in the 11be MCS table. The second component is used for indicating the margin-effective SNR, provided per spatial stream (SS), and encoded using 3 or 4 bits per SS. The margin-effective SNR per SS indicates the available SNR headroom on each stream relative to an effective SNR which is required for the recommended MCS and QAM pattern derived from the eELA request message or the PPDU.

The eELA scheme 2 defines the UEQM information within the eELA feedback message, applicable when the corresponding eELA request message specifies or the PPDU carrying the eELA request message implies the Nss. The responding device 11 determines the eELA feedback message including two components based on the Nss. The first component is used for indicating the recommended MCS and QAM pattern specifically chosen for the Nss, wherein the first component comprises MCS indication and QAM pattern indication, the number of bits of the MCS indication is one more than the number of bits of MCS indication in the 11be MCS table, and QAM pattern indication uses 2 or 3 bits. The second component is used for indicating the margin-effective SNR, provided per SS, and encoded using 3 or 4 bits per SS. The margin-effective SNR per SS indicates the available SNR headroom on each stream relative to an effective SNR which is required for the recommended MCS and QAM pattern.

The eELA scheme 3 defines the UEQM information within the eELA feedback message, applicable when the corresponding eELA request message specifies or the PPDU carrying the eELA request message implies an Nss, an MCS, and a QAM pattern. The responding device 11 determines the eELA feedback message including the margin-effective SNR per spatial stream based on the Nss, the MCS, and the QAM pattern, and being encoded using 3 or 4 bits per SS. The margin-effective SNR per SS indicates the available SNR headroom on each stream relative to an effective SNR which is required for the recommended MCS and QAM pattern derived from the eELA request message or the PPDU.

The eELA scheme 4 defines the UEQM information within the eELA feedback message, applicable when the corresponding eELA request message specifies or the PPDU carrying the eELA request message implies Nss. The responding device 11 determines the eELA feedback message including two components based on the Nss. The first component is used for indicating the recommended MCS chosen for the Nss, and the number of bits of this component is one more than the number of bits of MCS indication in the 11be MCS table. The second component is the margin-effective SNR, provided per SS, and encoded using 3 or 4 bits per SS. The margin-effective SNR per SS indicates the available SNR headroom on each stream relative to an effective SNR which is required for the recommended MCS.

The eELA scheme 5 defines the UEQM information within the eELA feedback message, applicable when the corresponding eELA request message specifies or the PPDU frame carrying the eELA request message implies a Nss, a QAM pattern, or a pre-designed high-ordered QAM (e.g., 256 QAM or 1024 QAM). The responding device 11 determines the eELA feedback message including two components based on the Nss, the QAM pattern, or the pre-designed high-ordered QAM. The first component is used for indicating a common offset for effective SNR, encoded using 6 bits. The second component is used for indicating a delta-effective SNR per SS, encoded using 4 bits. For example, the responding device 11 determines the eELA feedback message including two components based on the Nss and the QAM pattern derived from the eELA request or the PPDU, or the Nss derived from the eELA request or the PPDU and a pre-designed high-ordered QAM.

The eELA scheme 6 defines the UEQM information within the eELA feedback message, applicable when the corresponding eELA request message specifies or the PPDU carrying the eELA request message implies a Nss, a QAM pattern, or a pre-designed high-ordered QAM (e.g., 256 QAM or 1024 QAM). The responding device 11 determines the eELA feedback message including the effective SNR per SS encoded using 6 bits per SS. For example, the responding device 11 determines the eELA feedback message based on the Nss and the QAM pattern derived from the eELA request or the PPDU, or the Nss derived from the eELA request or the PPDU and a pre-designed high-ordered QAM.

In the embodiment, the UEQM information carried within the eELA feedback message provides versatile utility. Components of the UEQM information, excluding the specific QAM pattern indication, can also be employed for link adaptation purposes in scenarios utilizing only Equal Modulation (EQM). For EQM operation, the eELA system 100 supports configurations with up to eight spatial streams (SS). In contrast, when UEQM is employed, four spatial streams are supported. The UEQM information via the eELA feedback message may be triggered either by an explicit request from the requesting device 10 (solicited) or may be sent proactively by the responding device 11 (unsolicited). Furthermore, the UEQM information can be incorporated into the eELA feedback message irrespective of whether the transmission prompting the feedback (e.g., MAC Service Data Unit, MSDU) utilized EQM or UEQM. It is noted that the eELA feedback mechanism represents an optional enhancement layered upon the baseline Enhanced Link Adaptation (ELA) framework.

Regarding specific feedback encoding schemes, such as the previously mentioned eELA scheme 5, the “common offset” value can represent different calculated metrics. For example, it could be the average effective SNR computed across all relevant spatial streams, or it may correspond to the minimum or the maximum effective SNR value observed among the individual spatial streams. Further, the “delta-effective SNR per SS” for a particular spatial stream is defined as the difference between the effective SNR of the spatial stream and a common offset. Equivalently, the effective SNR for the spatial stream equals the sum of the common offset and the corresponding delta-effective SNR.

In the embodiment, the various SNR metrics reported in the eELA feedback message, such as the effective SNR, the delta-effective SNR, and the margin-effective SNR, can be derived from calculations based on the Received Bit Mutual Information Rate (RBIR). The RBIR-based SNR values can be computed relative to the specific QAM pattern identified from the eELA request message or the PPDU, relative to a QAM pattern recommended within the feedback itself, or relative to a predefined high-order QAM constellation, such as 256 QAM or 1024 QAM. Details of definitions and derivations of the RBIR-based SNR values are illustrated below.

The effective SNR for each spatial stream can be derived using an estimation based on the Received Bit Mutual Information Rate (RBIR). The RBIR estimation represents the symbol-level mutual information, conditioned on the specific M-ary Quadrature Amplitude Modulation (M-QAM) scheme being utilized. The derivation to convert the Signal-to-Interference-plus-Noise Ratio (SINR) measured per tone (subcarrier) into an RBIR-based effective SINR involves the following steps. First, the SINR for each tone n on a specific spatial stream iₛₛ, denoted as (iₛₛ, n), is converted into an intermediate mutual information value using an estimation function, Φ (SINR; M). The estimation function Φ (SINR; M) is defined as:

$$Φ ( SIN R ; M ) = {log}_{2} M - \frac{1}{M} {\sum }_{m = 1}^{M} {E}_{U} \{ {log}_{2} ( {\sum }_{k = 1}^{M} exp [ {\vert U \vert}^{2} - {\vert \sqrt{SIN R} ( {s}_{k} - {s}_{m} ) \vert}^{2} ] ) \}$$

M represents the modulation order of the M-QAM scheme (e.g., M=16 for 16-QAM, M=64 for 64-QAM), indicating the total number of distinct constellation symbols. SINR is the input Signal-to-Interference-plus-Noise Ratio for the specific tone being processed. sₖ and sₘ denote specific symbols within the M-QAM constellation set, where the indices k and m range from 1 to M. U is a random variable representing noise, modeled as a zero-mean complex Gaussian random variable with unit variance (e.g., U˜CN(0,1), normalized Gaussian random variable). E_{U} denotes the statistical expectation taken concerning the noise variable U.

Next, the RBIR for the spatial stream iₛₛ, denoted as RBIRᵢₛₛ, can be calculated by averaging the results of the Φ function across all relevant tones. If there are N tones considered (e.g., N subcarriers within an OFDM symbol), the calculation is:

$${RBIR}_{iss} = \frac{1}{N} {\sum }_{n = 1}^{N} Φ ( SIN R ( {i}_{ss} , n ) ; M )$$

Here, N is the total number of tones included in the averaging. SINR (iₛₛ, n) is the SINR measured on the n-th tone of the iₛₛ-th spatial stream. Finally, the calculated RBIRᵢₛₛ value for the spatial stream iₛₛ is converted into the effective SINR for the spatial stream iₛₛ, denoted as SINR_effᵢ_{ₛₛ}, by applying the inverse of the estimation function Φ:

$${SINR\_eff}_{{i}_{ss}} = {Φ}^{- 1} ( {RBIR}_{iss} ; M )$$

Φ⁻¹ represents the inverse function of Φ, which maps the calculated RBIR value back to an equivalent SINR value, given the modulation order M. The SINR_effᵢ_{ₛₛ} denotes the effective SINR metric for the spatial stream iₛₛ.

For the eELA scheme 5 and the eELA scheme 6, if it's specified to use a pre-designed high order QAM (for example 256 QAM or 1024 QAM), this pre-designed high order QAM is used for computing the RBIR. Otherwise, the QAM pattern derived from the eELA request or the PPDU is used for computing the RBIR. For the eELA scheme 1 and the eELA scheme 3, the QAM pattern derived from the eELA request or the PPDU is used for computing the RBIR.

It should be understood that within the framework of OFDM, the signal is transmitted over multiple orthogonal subcarriers. Although the orthogonality is designed to mitigate inter-carrier interference (ICI) arising from the OFDM signal itself under ideal conditions, real-world wireless channels typically experience interference from external sources as well as noise. The calculation method employed in the embodiment, starting from the SINR per tone and utilizing the RBIR estimation, explicitly accounts for the combined effects of the desired signal, the actual interference, and the noise present on each subcarrier. The effective SINR (SINR_effᵢ_{ₛₛ}) consolidates these effects into a single value for each spatial stream. The effective SINR corresponds to the equivalent SNR value required on an idealized reference channel (e.g., an interference-free additive white Gaussian noise channel, AWGN) to achieve the same mutual information rate as that obtained on the actual communication link.

Because the calculated metric provides a performance-equivalent SNR value, reflecting the actual channel conditions including interference, it can be effectively utilized and referred to as the effective SNR for the spatial stream. Therefore, the embodiment adopts the effective SNR per spatial stream (or preferably adopts the effective SINR per spatial stream) as the signal quality indicator for making link adaptation decisions.

In the following, the eELA subfield used for the eELA request message and feedback message is introduced. The eELA subfield contains specific information elements intended to support operations involving UEQM in addition to the information already specified within the conventional enhanced link adaptation (ELA) control subfield defined for Extremely High Throughput (EHT) systems. The UEQM information can include the following contents described in Table T2.

TABLE T2

| Information Field/Purpose | Details/Encoding |
|---|---|
| MCS Indication | One more bit in addition to the number of |
| | bits of MCS indication of the 11be MCS |
| | table. |
| UEQM Pattern and EQM | 2 bits option: 3 allowed UEQM patterns + |
| Indication | EQM |
| | 3 bits option: 1 bit for indicating |
| | UEQM/EQM + 2 bits for indicating 3 |
| | allowed UEQM patterns. |
| Per-Stream effective SNR | x bits per spatial stream (e.g, x bits/SS) to |
| Metric Indication | indicate margin-effective SNR for the |
| | indicated NSS, MCS, and UEQM pattern, |
| | effective SNR, or delta-effective SNR for the |
| | indicated NSS and UEQM pattern. |

In Table T2, the eELA subfield can incorporate several types of information elements to facilitate support for UEQM transmissions. The number of bits of the MCS indication is one more than the number of bits of MCS indication in the 11be MCS table. For the UEQM Pattern and EQM Indication, the eELA subfield may use 2 or 3 bits to indicate the applied modulation pattern. For the 2-bit option, using 2 bits can specify standard Equal Modulation (EQM) or three allowed UEQM patterns. For the 3-bit option, using 3 bits can employ one bit to indicate UEQM or EQM, and the remaining two bits to indicate three allowed UEQM patterns when UEQM is indicated. For the per-stream effective SNR metric indication, the eELA subfield can carry “x” bits per spatial stream (denoted as “x” bits/SS), where “x” is a variable number, to convey signal quality information. In one embodiment, the “x” bits may represent the margin-effective SNR for the indicated number of spatial streams Nss, MCS, and UEQM pattern. In another embodiment, the “x” bits can represent the effective SNR, or they can represent the delta-effective SNR for the indicated Nss and UEQM pattern.

Some embodiments are provided below to demonstrate encoding methods for the per-spatial stream (SS) signal quality metrics, such as the margin-effective SNR, the effective SNR, or the delta-effective SNR, as shown in Table T3.

TABLE T3

| | |
|---|---|
| Case | 3 bits/SS for margin-effective SNR per SS with [−4, +3] dB range |
| 1: | and 1 dB step size. |
| Case | 4 bits/SS for margin-effective SNR per SS with [−4, +3] dB range |
| 2: | and 0.5 dB step size. |
| Case | 4 bits/SS for margin-effective SNR per SS with [−8, +7] dB range |
| 3: | and 1 dB step size. |
| Case | 6 bits/SS for effective SNR per SS with [−10, +53] dB range and 1 |
| 4: | dB step size. |
| Case | 6 bits common offset for effective SNR with [−10, +53] dB range |
| 5: | and 1 dB step size), and 4 bits/SS for delta-effective SNR per SS |
| | with 15 dB range and 1 dB step size. |

In case 1, the margin-effective SNR per SS can be represented using 3 bits per spatial stream, covering a range from −4 dB to +3 dB with a resolution or step size of 1 decibel (dB). In case 2, 4 bits per spatial stream could be used to encode the margin-effective SNR per SS over the same range [−4, +3] dB, but providing a finer resolution with a 0.5 dB step size. In case 3, the margin-effective SNR per SS can be represented using 4 bits per spatial stream, and the 4 bits per spatial stream can cover a wider range from −8 dB to +7 dB, using the 1 dB step size. For encoding the effective SNR per SS, in case 4, the effective SNR per SS can be represented using 6 bits per spatial stream, and 6 bits per spatial stream can be employed to cover a range from −10 dB to +53 dB, with the 1 dB step size. In case 5, an alternative approach involves using a combination encoding: 6 bits represent a common offset for the effective SNR, covering a range of [−10, +53] dB with the 1 dB step size, supplemented by 4 bits per spatial stream to indicate a delta-effective SNR relative to the common offset, covering a 15 dB range with the 1 dB step size.

In the embodiment, the eELA feedback message, including elements pertinent to UEQM support, can be incorporated and reported within specific wireless communication frames. For example, the eELA feedback message can be included in a High Throughput Control (+HTC) frame or in a Multi-Station (Multi-STA) block Ack frame. For example, in one embodiment, the eELA information is located within an eELA control subfield embedded in the +HTC frame. It can be implemented either by redefining the existing enhanced link adaptation control subfield structure to include the necessary UEQM information elements, or by defining a new, distinct control subfield identifier (ID) specifically designated for carrying the eELA information in the +HTC frame, separate from the standard ELA control subfield. In some embodiment, the eELA control subfield is carried within a frame structure that includes both a compressed Block Acknowledgment (BA) and Quality of Service (QOS) Null data.

In another embodiment, the eELA information can be located within the Multi-STA block Ack frame. The Multi-STA block Ack frame includes Per AID TID Info subfield, which is identified by a pair of an Association Identifier (AID, e.g., AID11) and a Traffic Identifier (TID). To accommodate the eELA feedback message by using the Multi-STA block Ack frame, a specific Per AID TID Info subfield can be designated to carry the eELA feedback message pertinent to eELA. In one embodiment, either a special AID value or a special TID value can be used within the <AID, TID> pair to identify that the specific Per AID TID Info subfield (containing information for this <AID, TID> pair) contains the eELA feedback message. For instance, the Per AID TID Info subfield corresponding to a pair like <AID11, special TID> or <special AID, TID> contains the eELA UEQM information. Here, the “special AID” can be defined, for example, as an AID11 value greater than the standard range limit of 2007. The “special TID” can be selected from the reserved TID values, such as one of TIDs 8 through 13. Briefly, the block Ack frame can be a Multi-STA block Ack frame including the eELA feedback message. The eELA feedback message is contained within a Per AID TID Info subfield identified by a pair of AID and TID, wherein the pair of AID and TID comprises a special AID or a special TID.

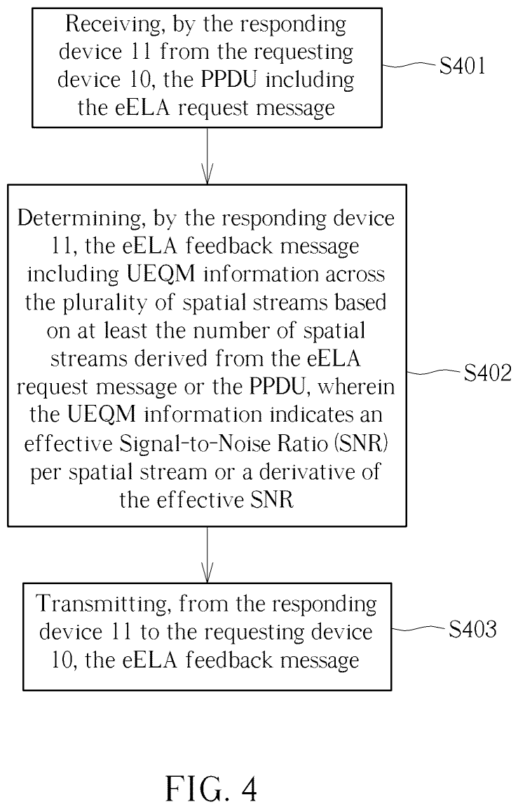

FIG. 4 is a flow chart of performing an eELA method by the eELA system 100. The eELA method includes steps S401 to S403. Any technology or hardware modification falls into the embodiments. Steps S401 to S403 are illustrated below.
Step S401: receiving, by the responding device 11 from the requesting device 10, the PPDU including the eELA request message;
Step S402: determining, by the responding device 11, the eELA feedback message including UEQM information across the plurality of spatial streams based on at least the number of spatial streams derived from the eELA request message or the PPDU, wherein the UEQM information indicates an effective Signal-to-Noise Ratio (SNR) per spatial stream or a derivative of the effective SNR;
Step S403: transmitting, from the responding device 11 to the requesting device 10, the eELA feedback message.

In some embodiments, the derivative of the effective SNR may be a margin-effective SNR per spatial stream or delta-effective SNR per spatial stream.

In some embodiments, the effective SNR per spatial stream is derived from a received bit mutual information rate (RBIR) per spatial stream, and the RBIR per spatial stream is based on symbol level mutual information conditioned on a modulation order of a quadrature amplitude modulation (QAM) scheme. In some embodiments, the QAM scheme may be a pre-designed high order QAM. In some embodiments, the QAM scheme may derived from a QAM pattern derived from the eELA request or the PPDU.

Details of steps S401 to S403 are previously illustrated. Thus, they are omitted here. The eELA system 100 offers improvements over conventional link adaptation methods, such as those defined for IEEE 802.11 EHT. Conventional ELA often suffers from reliability and interoperability issues related to Modulation and Coding Scheme (MCS) Feedback (MFB) variations, relies on less precise metrics like Packet Error Rate (PER), and lacks optimized support for UEQM transmissions across multiple spatial streams. The eELA system 100 employs a refined feedback mechanism between the requesting device 10 and the responding device 11. The operation involves the requesting device 10 transmitting the PPDU with eELA request message. The responding device 11 evaluates the received signal quality, determining the effective SNR for each spatial stream. This effective SNR metric is preferably derived using RBIR estimations, which process the SINR value per tone to accurately capture channel conditions, and map them to a performance-equivalent SNR. Subsequently, the responding device 11 generates the eELA feedback message including UEQM information, which includes at least the effective SNR per spatial stream or a derivative of the effective SNR per spatial stream, and transmits this message back to the requesting device 10. The eELA system 100 provides robust support for UEQM by providing granular, per-stream effective SNR feedback or a derivative of the effective SNR per spatial stream necessary for the precise, independent adaptation of modulation and coding on each spatial stream. The use of the more accurate RBIR-based effective SNR results in more optimal MCS and QAM pattern selection compared to PER or average SNR metrics.

In summary, the embodiments provide an eELA method and system designed to significantly improve wireless communication performance, particularly for using UEQM across multiple spatial streams. The eELA method involves a refined feedback mechanism where the responding device, upon receiving the PPDU carrying an eELA request from the requesting device, determines the UEQM information and transmits it back to the requesting device. Further, the eELA method uses the RBIR-based effective SNR per spatial stream as a highly accurate link quality metric. The feedback UEQM information includes at least the effective SNR per stream or a derivation of the effective SNR per stream. Compared to conventional ELA methods (e.g., in IEEE 802.11 EHT) that often rely on less precise metrics like PER, suffer from interoperability issues, and lack adequate UEQM support, the eELA system of the embodiments offers substantial advantages. For example, the eELA system enables robust, granular adaptation specifically tailored for UEQM, enhances overall link performance and throughput due to the improved feedback accuracy derived from the effective SNR metric, and increases reliability. Further, the embodiments can be applied to wireless communication systems employing OFDM and MIMO technologies, including next-generation Wi-Fi networks and devices such as access points and stations requiring sophisticated link adaptation capabilities for both UEQM and EQM scenarios, offering a valuable advancement in optimizing wireless link efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An enhanced link adaptation (eELA) method comprising:
receiving, by a responding device from a requesting device, a physical layer protocol data unit (PPDU) comprising an eELA request message;
determining, by the responding device, an eELA feedback message comprising unequal quadrature amplitude modulation (UEQM) information across a plurality of spatial streams based on at least the number of spatial streams derived from the eELA request message or the PPDU; and
transmitting, from the responding device to the requesting device, the eELA feedback message;
wherein the UEQM information indicates an effective Signal-to-Noise Ratio (SNR) per spatial stream or a derivative of the effective SNR.

2. The method of claim 1, wherein the effective SNR per spatial stream is derived from a received bit mutual information rate (RBIR) per spatial stream, and the RBIR per spatial stream is based on symbol level mutual information conditioned on a modulation order of a quadrature amplitude modulation (QAM) scheme.

3. The method of claim 1, wherein determining the eELA feedback message comprising the UEQM information by the responding device comprises:
determining the UEQM information comprising a recommended modulation and coding scheme (MCS) and a margin-effective SNR per spatial stream by the responding device based on the number of spatial streams and a quadrature amplitude modulation (QAM) pattern derived from the eELA request message or the PPDU.

4. The method of claim 1, wherein determining the eELA feedback message comprising the UEQM information by the responding device comprises:
determining the UEQM information comprising a recommended modulation and coding scheme (MCS), a quadrature amplitude modulation (QAM) pattern, and a margin-effective SNR per spatial stream by the responding device based on the number of spatial streams derived from the eELA request message or the PPDU.

5. The method of claim 1, wherein determining the eELA feedback message comprising the UEQM information by the responding device comprises:
determining a margin-effective SNR per spatial stream by the responding device based on the number of spatial streams, a modulation and coding scheme (MCS), and a quadrature amplitude modulation (QAM) pattern derived from the eELA request message or the PPDU.

6. The method of claim 1, wherein determining the eELA feedback message comprising the UEQM information by the responding device comprises:
determining a recommended equal modulation and coding scheme (MCS) and a margin-effective SNR per spatial stream by the responding device based on the number of spatial streams derived from the eELA request message or the PPDU.

7. The method of claim 1, wherein determining the eELA feedback message comprising the UEQM information by the responding device comprises:
determining a common offset for the effective SNR per spatial stream and a delta-effective SNR per spatial stream by the responding device based on the number of spatial streams and a quadrature amplitude modulation (QAM) pattern derived from the eELA request message or the PPDU, or the number of spatial streams derived from the eELA request message or the PPDU and a pre-designed high-ordered QAM.

8. The method of claim 7, wherein the effective SNR for a spatial stream in a plurality of spatial streams is equal to a sum of a common offset and the delta-effective SNR corresponding to the spatial stream.

9. The method of claim 1, wherein determining the eELA feedback message comprising the UEQM information by the responding device comprises:
determining the effective SNR per spatial stream by the responding device based on the number of spatial streams and a quadrature amplitude modulation (QAM) pattern derived from the eELA request message or the PPDU or the number of spatial streams derived from the eELA request message or the PPDU and a pre-designed high-ordered QAM.

10. The method of claim 1, wherein the eELA feedback message is carried by a multi-station (Multi-STA) block ack frame, and wherein the eELA feedback message is contained within per AID TID Info subfield identified by a pair of AID and TID in the Multi-STA block ack frame, wherein the pair of AID and TID comprises a special AID or a special TID.

11. A communication device comprising:
a transceiver configured to communicate wirelessly; and
a processor coupled to the transceiver and configured to perform operations comprising:
receiving, via the transceiver, a physical layer protocol data unit (PPDU) comprising an enhanced link adaptation (eELA) request message;
determining an eELA feedback message comprising unequal quadrature amplitude modulation (UEQM) information across a plurality of spatial streams based on at least the number of spatial streams derived from the eELA request message or the PPDU; and
transmitting, via the transceiver, the eELA feedback message;
wherein the UEQM information indicates an effective Signal-to-Noise Ratio (SNR) per spatial stream or a derivative of the effective SNR per spatial stream.

12. The communication device of claim 11, wherein the effective SNR per spatial stream is derived from a received bit mutual information rate (RBIR) per spatial stream, and the RBIR per spatial stream is based on symbol level mutual information conditioned on a modulation order of a quadrature amplitude modulation (QAM) scheme.

13. The communication device of claim 11, wherein the determining of the eELA feedback message comprising the UEQM information comprises determining the UEQM information comprising a recommended modulation and coding scheme (MCS) and a margin-effective SNR per spatial stream based on the number of spatial streams and a quadrature amplitude modulation (QAM) pattern derived from the eELA request message or the PPDU.

14. The communication device of claim 11, wherein the determining of the eELA feedback message comprising the UEQM information comprises determining a margin-effective SNR per spatial stream based on the number of spatial streams, a modulation and coding scheme (MCS), and a quadrature amplitude modulation (QAM) pattern derived from the eELA request message or the PPDU.

15. The communication device of claim 11, wherein the determining of the eELA feedback message comprising the UEQM information comprises determining a recommended equal modulation and coding scheme (MCS) and a margin-effective SNR per spatial stream based on the number of spatial streams derived from the eELA request message or the PPDU.

16. The communication device of claim 11, wherein the determining of the eELA feedback message comprising the UEQM information comprises determining a recommended equal modulation and coding scheme (MCS) and a margin-effective SNR per spatial stream by the responding device based on the number of spatial streams derived from the eELA request message or the PPDU.

17. The communication device of claim 11, wherein the determining of the eELA feedback message comprising the UEQM information comprises determining a common offset for the effective SNR per spatial stream and a delta-effective SNR per spatial stream by the responding device based on the number of spatial streams and a quadrature amplitude modulation (QAM) pattern derived from the eELA request message or the PPDU, or the number of spatial streams derived from the eELA request message or the PPDU and a pre-designed high-ordered QAM.

18. The communication device of claim 11, wherein the effective SNR for a spatial stream in a plurality of spatial streams is equal to a sum of a common offset and the delta-effective SNR corresponding to the spatial stream.

19. The communication device of claim 11, wherein the determining of the eELA feedback message comprising the UEQM information comprises: determining the effective SNR per spatial stream by the responding device based on the number of spatial streams and a quadrature amplitude modulation (QAM) pattern derived from the eELA request message or the PPDU or the number of spatial streams derived from the eELA request message or the PPDU and a pre-designed high-ordered QAM.

20. The communication device of claim 11, wherein the eELA feedback message is carried by a multi-station (Multi-STA) block ack frame, and wherein the eELA feedback message is contained within per AID TID Info subfield identified by a pair of AID and TID in the Multi-STA block ack frame, wherein the pair of AID and TID comprises a special AID or a special TID.
